(19) United States
(12) Patent Application Publication
(10) Pub. No.: US 2026/0008508 A1
(43) Pub. Date: Jan. 8, 2026

(54) BELT IDLER ASSEMBLY FOR SNOWMOBILE

(71) Applicant: Textron Inc., Providence, RI (US)

(72) Inventors: Nathan Deselich, Providence, RI (US); Jayden Trana, Providence, RI (US); Samuel Sandoz, Providence, RI (US)

(21) Appl. No.: 18/763,529

(22) Filed: Jul. 3, 2024

(51) Int. Cl. B62D 55/30; B62D 55/12; B62M 27/02

(52) U.S. Cl. CPC B62D 55/305; B62D 55/12; B62M 27/02

(57) ABSTRACT

A belt idler assembly for changing a path length of a drive belt of a belt assembly of a snowmobile includes an idler bracket configured to couple to a belt housing of a belt assembly, a post configured to be positioned between the idler bracket and the belt housing, and a bearing coupled to the post. The idler bracket includes a first bracket portion, a plurality of second bracket portions extending from opposing ends of the first bracket portion, and a plurality of third bracket portions extending from each of the second bracket portions. A first of the third bracket portions is configured to engage with a first interface of the housing and a second of the third bracket portions is configured to engage with a second interface of the housing. The bearing defines a bearing surface configured to engage the drive belt.

### BACKGROUND

The present application relates to a drive system of a vehicle. More specifically, the present application relates to a belt drive system of a snowmobile.

### SUMMARY

One embodiment relates to a belt idler assembly for changing a path length of a drive belt of a belt assembly of a snowmobile. The belt idler assembly includes an idler bracket configured to couple to a belt housing of the belt assembly, a plurality of fasteners, a post configured to be positioned between the idler bracket and the belt housing, and a bearing coupled to the post. The idler bracket includes a first bracket portion, a plurality of second bracket portions extending from opposing ends of the first bracket portion, and a plurality of third bracket portions extending from each of the second bracket portions. Each of the second bracket portions define a first aperture configured to align with a second aperture of the belt housing. A first of the third bracket portions is configured to engage with a first interface of the housing and a second of the third bracket portions is configured to engage with a second interface of the housing. The plurality of fasteners are configured to extend through the first apertures and the second apertures to couple the idler bracket to the belt housing. The bearing defines a bearing surface configured to engage the drive belt.

Another embodiment relates to a vehicle. The vehicle includes a frame, a tractive assembly coupled to the frame, a prime mover configured to provide power to the tractive assembly to drive the tractive assembly, a belt assembly configured to transfer the power from the prime mover to the tractive assembly, and a belt idler. The tractive assembly is configured to propel the vehicle. The belt assembly includes a housing, a first sprocket rotatably coupled to the housing and configured to receive the power from the prime mover, a second sprocket rotatably coupled to the housing and configured to provide the power to the tractive assembly, and a belt coupled to the first sprocket and the second sprocket. The belt is configured to transfer the power between the first sprocket and the second sprocket. The belt idler assembly includes an idler bracket coupled to the housing, a post positioned between the housing and the idler bracket, and a bearing coupled to the post and positioned between the first sprocket and the second sprocket. The belt wraps around at least a portion of the bearing such that a path length of the belt is greater than a direct path length of the belt when the belt extends directly between the first sprocket and the second sprocket.

Still another embodiment relates to a transmission assembly for transferring power between a prime mover and a tractive assembly of a snowmobile. The transmission assembly includes a belt assembly configured to transfer the power from the prime mover to the tractive assembly and a belt idler assembly. The belt assembly includes a housing comprising a first housing portion and a second housing portion extending from an edge of the first housing portion, a first sprocket rotatably coupled to the housing, a second sprocket rotatably coupled to the housing, and a belt coupled to the first sprocket and the second sprocket. The first sprocket and the second sprocket are positioned within the housing cavity. The belt is configured to transfer the power between the first sprocket and the second sprocket. The belt idler assembly includes an idler bracket coupled to (i) a first portion of the second housing portion on a first side of the housing cavity and (ii) a second portion of the second housing portion on a second opposing side of the housing cavity, a post positioned between the housing and the idler bracket, and a bearing coupled to the post. The belt wraps around at least a portion of the bearing such that a path length of the belt is greater than a direct path length of the belt when the belt extends directly between the first sprocket and the second sprocket.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a side view of a vehicle, according to an exemplary embodiment.

FIG. 2 is a schematic block diagram of the vehicle of FIG. 1, according to an exemplary embodiment.

FIG. 3 is a side view of a transmission assembly of the vehicle of FIG. 1, according to an exemplary embodiment.

FIG. 4 is a front perspective view of the transmission assembly of FIG. 3, according to an exemplary embodiment.

FIG. 5 is a rear perspective view of the transmission assembly of FIG. 3, according to an exemplary embodiment.

FIG. 6 is a side view of a portion of a belt assembly of the transmission assembly of FIG. 3, according to an exemplary embodiment.

FIG. 7 is an exploded perspective view of the belt assembly of FIG. 6, according to an exemplary embodiment.

FIG. 8 is a cross-section view of a portion of the belt assembly of FIG. 6, according to an exemplary embodiment.

FIG. 9 is a detailed view of a portion of the belt assembly of FIG. 8, according to an exemplary embodiment.

FIG. 10 is a perspective view of a portion of a belt idler assembly of the belt assembly of FIG. 6, according to an exemplary embodiment.

FIG. 11 is a perspective view of a bracket of the belt idler assembly of FIG. 10, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle of the present disclosure includes a transmission configured to facilitate selectively changing a gear ratio of a belt assembly configured to transfer power between a tractive assembly of the vehicle and a prime mover of the vehicle configured to provide power to the tractive assembly to drive the tractive assembly. The belt assembly includes a belt housing including a first housing portion and a second housing portion extending from edges of the first housing portion, a first sprocket rotatably coupled to the belt housing and configured to receive the power from the prime mover, a second sprocket rotatably coupled to the belt housing and configured to provide the power to the tractive assembly, and a belt coupled to the first sprocket and the second sprocket and configured to transfer the power between the first sprocket and the second sprocket. The first housing portion and the second housing portion collectively define a housing cavity that receives the first sprocket, the second sprocket, and the belt. The transmission also includes a belt idler assembly coupled to the belt housing of the belt assembly and configured to allow for additional configurations of first sprockets, second sprockets, and belts to be installed in the belt assembly that result in different gear ratios of the belt assembly when transferring the power between the prime mover and the tractive assembly.

The belt idler assembly includes an idler bracket coupled to the housing of belt assembly, a post coupled between the belt bracket and the housing, and a bearing coupled to the post and configured to engage the belt. The idler bracket includes a first bracket portion extending across the housing cavity, second bracket portions extending from opposing ends of the first bracket portion and coupled to the second housing portion, and third bracket portions extending from each of the second bracket portions and engaging the second housing portion to prevent movement of the idler bracket relative to the belt housing. When the belt is at least partially wrapped around the bearing of the belt idler assembly, a path length of the belt through the belt assembly may be greater than a direct path length of the belt through the belt assembly if the belt were to extend directly between the first sprocket and the second sprocket. Due to the belt idler assembly, the belt assembly may accommodate belts of varying lengths, as the path length of the belts through the belt assembly may be changed by at least partially wrapping the belts around the bearing. By changing the path lengths of the belts through the belt assembly, the belts may remain engaged with the first sprocket and the second sprocket despite the belts having varying lengths. Additionally, due to the belt idler assembly, the belt assembly may include first sprockets and/or second sprockets of varying sizes, as the changing the path length of the belts by at least partially wrapping the belts around the bearing may allow for the belts to remain engaged with the first sprockets and/or the second sprockets despites the first sprockets and/or the second sprockets having varying sizes. As a result, the belt idler assembly may allow for combinations of the first sprocket, the second sprocket and the belt to be included in the belt assembly that typically require distances other than a first distance between the first sprocket and the second sprocket defined by the belt housing. Additionally, when the belt is at least partially wrapped around the bearing of the belt idler assembly, engagement lengths between the belt and the first sprocket and/or the second sprocket may be increased compared to if the belt were to extend directly between the first sprocket and the second sprocket, decreasing loads on elements of the first sprocket and/or the second sprocket and elements of the belt configured to transfer loads between the first sprocket and the belt and/or the second socket and the belt.

### Overall Vehicle

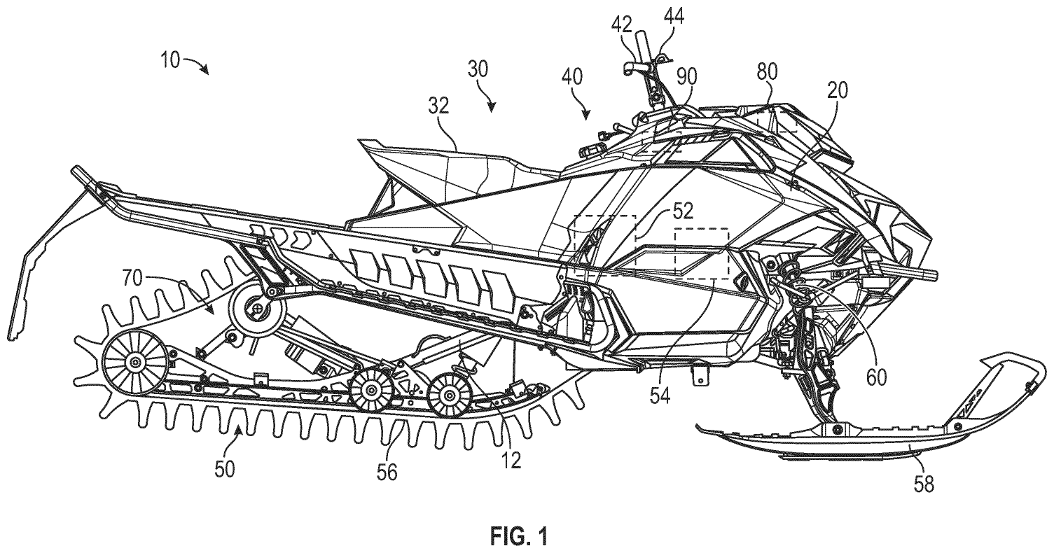

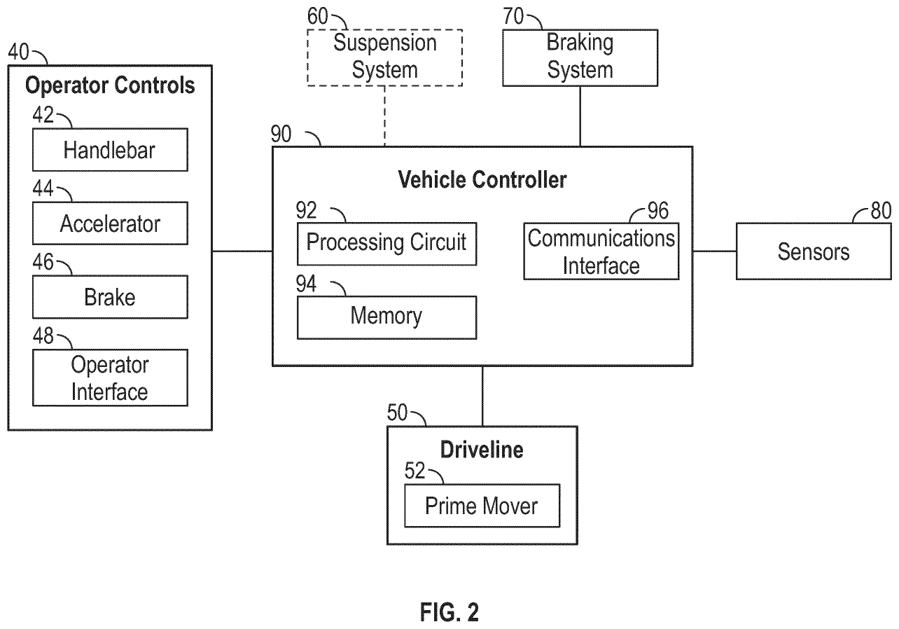

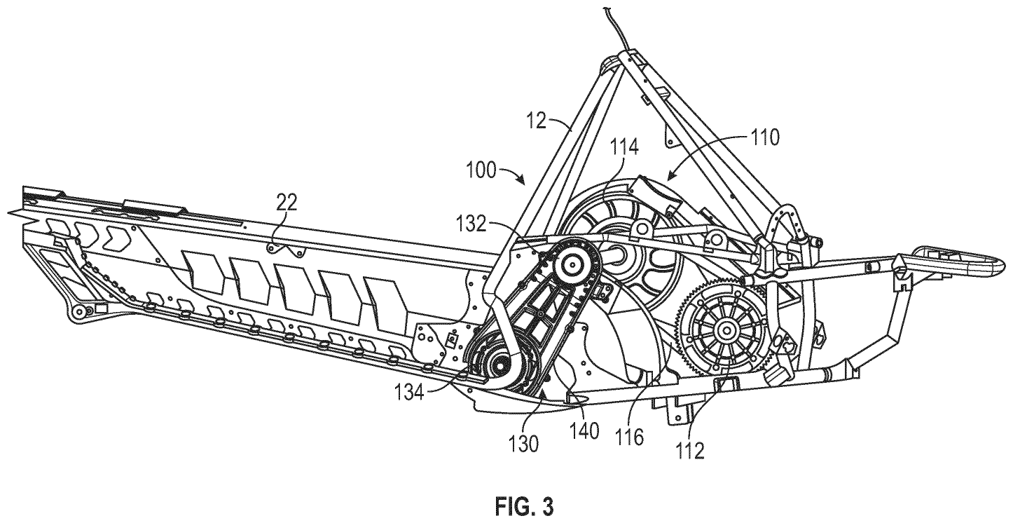

As shown in FIGS. 1 and 2, a machine or vehicle, shown as vehicle 10, includes a chassis, shown as frame 12, a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 80; and a vehicle control system, shown as vehicle controller 90, coupled to the operator controls 40, the driveline 50, the suspension system 60, the braking system 70, and the sensors 80. In some embodiments, the vehicle 10 includes more or fewer components. As shown in FIG. 3, the body 20 include a tunnel assembly, shown as tunnel 22, configured to receive at least a portion of the driveline 50 to prevent the portion of the driveline 50 from transferring material (e.g., snow, rocks, etc.) into the occupant seating area 30.

According to an exemplary embodiment, the vehicle 10 is a tracked, winter-focused off-road machine or vehicle configured to be operated on a snowy and/or icy surface (e.g., operated in snow, on ice, etc.). In some embodiments, the tracked, winter-focused off-road machine or vehicle is a lightweight or recreational machine or vehicle such as a snowmobile, a snow bike, a snow scooter, a snow all-terrain vehicle (“ATV”), a snow utility task vehicle (“UTV”), a snow plow machine, and/or another type of lightweight or recreational machine configured to be operated on a snowy and/or icy surface. In other embodiments, the tracked, snow-focused off-road machine or vehicle is a large machine or vehicle such as a snowcat, a snow groomer, a snow plow machine, a tractor, and/or another type of large machine or vehicle configured to be operated on a snowy and/or icy surface. In still other embodiments, the vehicle 10 is a non-tracked, off-road machine or vehicle such as an ATV, a UTV, a dirt bike, and/or another type of non-tracked, off-road machine or vehicle.

According to the exemplary embodiment shown in FIG. 1, the occupant seating area 30 includes a first seat, shown as operator seat 32, configured to support an operator of the vehicle 10. In some embodiments, the occupant seating area 30 includes a double seat configured to support the operator of the vehicle 10 and a passenger of the vehicle 10 behind the operator, or a triple seat configured to support the operator of the vehicle 10 and two passengers of the vehicle 10 behind the operator. In some embodiments, the occupant seating area 30 includes a second seat positioned rearward of or to the side of the operator seat 32. The second seat may be configured to support passengers of the vehicle 10. In some embodiments, in addition to or in place of the second seat, the vehicle 10 includes one or more rear accessories. Such rear accessories may include a ski rack, a bed, a cargo body (e.g., for a storage, etc.), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a handlebar, a steering column, a handlebar assembly, joystick(s), a steering wheel, etc.), shown as handlebar 42, an accelerator interface (e.g., a pedal, a throttle, a throttle lever, etc.), shown as accelerator 44, a braking interface (e.g., a brake pedal, a brake lever, a brake arm, etc.), shown as brake interface 46, and one or more additional interfaces (e.g., a light control interface, an operational mode interface, etc.), shown as operator interfaces 48. The operator interface 48 may include one or more displays and one or more input devices. The one or more displays may be or include a touchscreen, an LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., tracks, treads, axles, differentials, etc.), shown as rear tractive assembly 56, and a second tractive assembly (e.g., skis, runners, slides, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system.

According to the exemplary embodiment shown in FIG. 1, the rear tractive assembly 56 includes a rear tractive element that is configured as a track and the front tractive assembly 58 includes front tractive elements configured as skis. For example, the rear tractive element may be configured as a track configured to engage a snowy surface in order to drive the vehicle 10 and the front skis may be configured to slide or glide along the snowy surface. In some embodiments, the rear tractive assembly 56 includes a plurality of the rear tractive elements configured as tracks. In some embodiments, the rear tractive assembly 56 is at least partially disposed within the tunnel 22. By way of example, a top portion of the rear tractive assembly 56 may be disposed within the tunnel 22 to prevent the rear tractive assembly 56 from transferring snow into the occupant seating area 30. In some embodiments, the front tractive assembly 58 includes front tractive elements that are configured as tracks. In other embodiments, the front tractive assembly 58 and the rear tractive assembly 56 include tractive elements that are configured as wheels.

According to an exemplary embodiment, the prime mover 52 is configured to provide power to drive the rear tractive assembly 56 (e.g., to provide rear-track drive, etc.). In some embodiments, the prime mover 52 is configured to provide power to drive the rear tractive assembly 56 and/or the front tractive assembly 58 (e.g., to provide front-track drive, to provide all-track drive, etc.). In some embodiments, the driveline 50 includes a transmission device (e.g., a gearbox, a continuous variable transmission (“CVT”), the transmission assembly 100, etc.) positioned between (a) the prime mover 52 and (b) the rear tractive assembly 56. In a non-track arrangement, the rear tractive assembly 56 may include a drive shaft, a differential, and/or an axle. In such non-track arrangement, the rear tractive assembly 56 includes two axles or a tandem axle arrangement. According to an exemplary embodiment, the front tractive assembly 58 is steerable (e.g., using the handlebar 42). In some embodiments, the rear tractive assembly 56 is additionally or alternatively steerable. In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first of the prime movers 52 that drives a first one of the rear tractive elements and a second of the prime movers 52 that drives a second one of the rear tractive elements when the rear tractive assembly 56 includes two rear tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

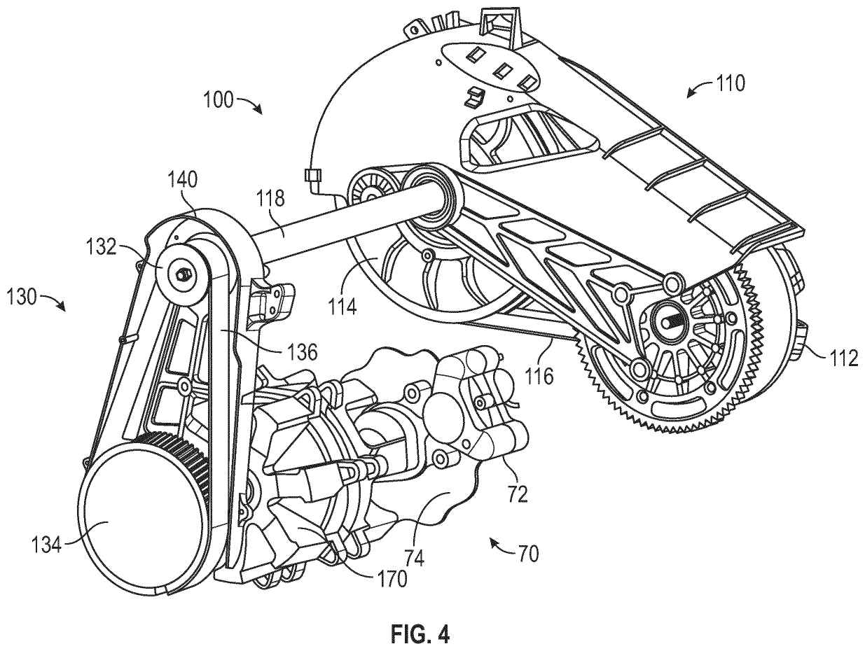

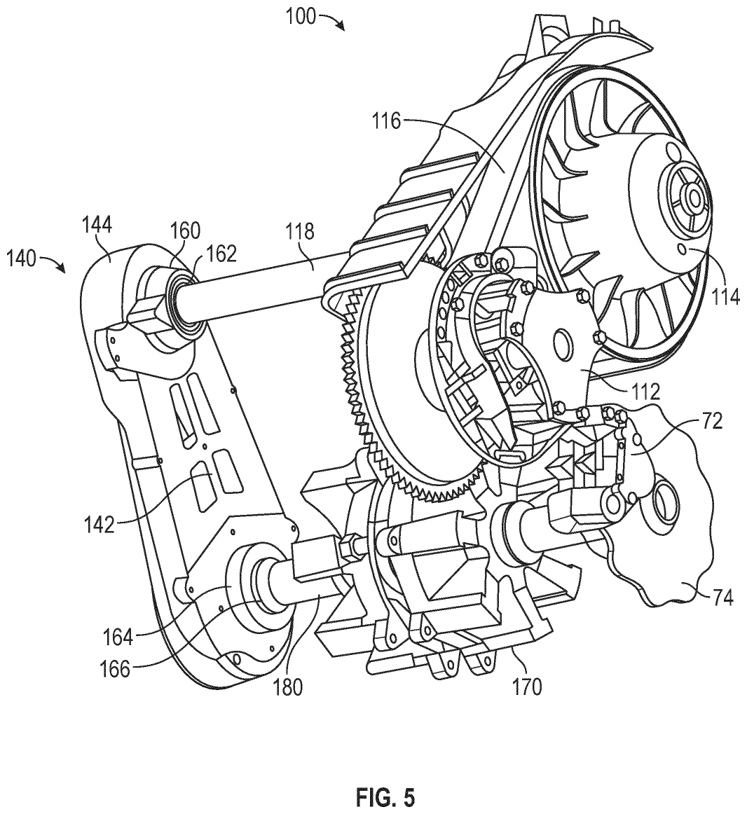

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include one or more rear braking components positioned to facilitate braking one or more components of the rear tractive assembly 56 (e.g., the rear axle, the rear tractive elements, etc.). In some embodiments (e.g., embodiments with two rear tractive elements), the one or more rear braking components include two rear braking components, one positioned to facilitate braking each of the rear tractive elements. As shown in FIGS. 4 and 5, the braking system 70 includes a brake assembly (e.g., a braking element, etc.), shown as brake 72, coupled to the frame 12 and/or the body 20, and a brake disk, shown as brake disk 74, coupled to a rotating component of the driveline 50. The brake 72 is configured to selectively engage the brake disk 74 to facilitate braking the rotating component of the driveline 50 (e.g., via friction, the transmission assembly 100, etc.).

The sensors 80 may include various sensors positioned about the vehicle 10 to acquire vehicle information or vehicle data regarding operation of the vehicle 10 and/or the location thereof. By way of example, the sensors 80 may include an accelerometer, a gyroscope, a compass, a position sensor (e.g., a GPS sensor, etc.), suspension sensor(s), wheel/track sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 80 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the 10 vehicle, suspension travel of components of the suspension system 60, and/or other vehicle telemetry data.

The vehicle controller 90 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 90 includes a processing circuit 92, a memory 94, and a communications interface 96. The processing circuit 92 may include an ASIC, one or more FPGAs, a DSP, circuits containing one or more processing components, circuitry for supporting a microprocessor, a group of processing components, or other suitable electronic processing components. In some embodiments, the processing circuit 92 is configured to execute computer code stored in the memory 94 to facilitate the activities described herein. The memory 94 may be any volatile or non-volatile or non-transitory computer-readable storage medium capable of storing data or computer code relating to the activities described herein. According to an exemplary embodiment, the memory 94 includes computer code modules (e.g., executable code, object code, source code, script code, machine code, etc.) configured for execution by the processing circuit 92. In some embodiments, the vehicle controller 90 may represent a collection of processing devices. In such cases, the processing circuit 92 represents the collective processors of the devices, and the memory 94 represents the collective storage devices of the devices.

In one embodiment, the vehicle controller 90 is configured to selectively engage, selectively disengage, control, or otherwise communicate with components of the vehicle 10 (e.g., via the communications interface 96, a controller area network (“CAN”) bus, etc.). According to an exemplary embodiment, the vehicle controller 90 is coupled to (e.g., communicably coupled to) components of the operator controls 40 (e.g., the handlebar 42, the accelerator 44, the brake interface 46, the operator interface 48, etc.), components of the driveline 50 (e.g., the prime mover 52), components of the braking system 70, and the sensors 80. By way of example, the vehicle controller 90 may send and receive signals (e.g., control signals, location signals, etc.) with the components of the operator controls 40, the components of the driveline 50, the components of the braking system 70, the sensors 80, and/or remote systems or devices (via the communications interface 96 as described in greater detail herein).

### Transmission Assembly

As shown in FIGS. 3-5, the driveline 50 includes a transmission (e.g., a drivetrain, a transmission system, a power transfer assembly, etc.), shown as transmission assembly 100, coupled between the prime mover 52 and the rear tractive assembly 56. According to an exemplary embodiment, the transmission assembly 100 is configured to transfer power (e.g., motive power, torque, etc.) between the prime mover 52 and the rear tractive assembly 56. In some embodiments, the transmission assembly 100 is additionally or alternatively configured to transfer power between the prime mover 52 and the front tractive assembly 58 (e.g., in embodiments where the front tractive assembly 58 includes tracks or wheels). According to an exemplary embodiment, the transmission assembly 100 is configured to manipulate (e.g., reduce, increase, etc.) an input (e.g., a torque, speed, power, etc.) provided by the prime mover 52 to the front tractive assembly 58 and/or the rear tractive assembly 56 when the transmission assembly 100 transfers the power between (i) the prime mover 52 and (ii) the front tractive assembly 58 and/or the rear tractive assembly 56.

As shown in FIGS. 3 and 4, the transmission assembly 100 includes a first or transmission input assembly (e.g., a continuous variable transmission clutch, etc.), shown as clutch assembly 110, coupled to the prime mover 52 and configured to receive the power provided by the prime mover 52; a second or transmission output assembly (e.g., torque transfer system, etc.), shown as belt assembly 130, coupled to the clutch assembly 110 and configured to receive power from the clutch assembly 110; and a third or tractive output assembly (e.g., a drive cog, a drive gear, a drive wheel, a track sprocket, etc.), shown as drive sprocket 170, configured to engage the rear tractive assembly 56 and provide power to the rear tractive assembly 56 to drive the rear tractive assembly 56; and a shaft (e.g., a torque shaft, etc.), shown as drive shaft 180, (a) coupled to the belt assembly 130 and configured to receive power from the belt assembly 130, (b) coupled to the drive sprocket 170 and configured to provide power to the drive sprocket 170, and (c) coupled to the brake disk 74 and configured to receive braking power from the brake 72 via the brake disk 74 to brake the driveline 50. In some embodiments, the drive sprocket 170 and/or the belt assembly 130 are additionally or alternatively coupled to the front tractive assembly 58. By way of example, the prime mover 52 may generate power for driving the rear tractive assembly 56 and provide the power to the clutch assembly 110, the clutch assembly 110 may provide the power to the belt assembly 130, the belt assembly 130 may provide the power to the drive shaft 180, and the drive shaft 180 may provide the power to the drive sprocket 170, which uses the power to drive the rear tractive assembly 56. In other embodiments, the transmission assembly 100 includes a different configuration of components configured to transfer the power provided by the prime mover 52 to the front tractive assembly 58 and/or the rear tractive assembly 56. By way of example, the transmission assembly 100 may not include the clutch assembly 110 and the prime mover 52 may directly provide the power to the belt assembly 130.

As shown in FIGS. 4 and 5, the clutch assembly 110 includes a primary clutch assembly (e.g., a first clutch wheel, etc.), shown as primary clutch 112, coupled to the prime mover 52 and configure to be driven by the prime mover 52, a secondary clutch assembly (e.g., a second clutch wheel, etc.), shown as secondary clutch 114, a first belt (e.g., a first torque transfer belt, etc.), shown as clutch belt 116, engaged with the primary clutch 112 and the secondary clutch 114 and configured to be driven by the rotation of the primary clutch 112 to rotate the secondary clutch 114, and a first shaft (e.g., a power shaft, etc.), shown as jack shaft 118, coupled to the secondary clutch 114 and configured to rotate with the secondary clutch 114. As the prime mover 52 drives the primary clutch 112, the power provided by the prime mover 52 is transferred through the clutch assembly 110 to the jack shaft 118 through the rotation of the primary clutch 112 and the secondary clutch 114. In some embodiments, the clutch assembly 110 is configured as a continuous variable transmission clutch (e.g., a CVT system, etc.). By way of example, the primary clutch 112 and the secondary clutch 114 may each include a stationary sheave and moveable sheave. As a rotational speed of the primary clutch 112 and the secondary clutch 114 increase (e.g., based on a speed of the prime mover 52 increasing, etc.), the moveable sheaves of the primary clutch 112 and the secondary clutch 114 are actuated toward or away from the stationary sheave of the primary clutch 112 and the secondary clutch 114. As the moveable sheaves are actuated toward or away from the stationary sheaves, the clutch belt 116 may move between different diameters of the primary clutch 112 and the secondary clutch 114 to change an effective gear ratio of the clutch assembly 110. The clutch assembly 110 may allow for smooth and continuous delivery of the power provided by the prime mover 52 via the jack shaft 118 through the rotation of the jack shaft 118.

As shown in FIG. 4, the belt assembly 130 includes a first sprocket (e.g., first drive sprocket, etc.), shown as top drive sprocket 132, coupled to the jack shaft 118 and configured to rotate with the jack shaft 118, a second sprocket (e.g., a second drive sprocket, etc.), shown as bottom drive sprocket 134, coupled to the drive shaft 180 and configured to rotate with the drive shaft 180, and a second belt (e.g., belt system belt, etc.), shown as drive belt 136, engaged with the top drive sprocket 132 and the bottom drive sprocket 134 and configured to be driven by the top drive sprocket 132 to drive the bottom drive sprocket 134, and a housing (e.g., a belt bracket, a belt frame, etc.), shown as belt housing 140, coupled to the frame 12 and/or the body 20 and configured to house the top drive sprocket 132, the bottom drive sprocket 134, and/or drive belt 136. By way of example, as the top drive sprocket 132 is rotated by the jack shaft 118, the power provided by the jack shaft 118 to the top drive sprocket 132 is transferred through the drive belt 136 to the bottom drive sprocket 134 through the drive belt 136. By transferring the power from the top drive sprocket 132 to the bottom drive sprocket 134 via the drive belt 136, the belt assembly 130 may offset the rotation associated with the power received from the clutch assembly 110 from a first axis extending along the jack shaft 118 (e.g., the first axis defined by the jack shaft 118, the first axis extending along a length of the jack shaft 118, etc.) to a second axis extending along the drive shaft 180 (e.g., the first axis defined by the drive shaft 180, the first axis extending along a length of the drive shaft 180, etc.). By offsetting the rotation from the first axis extending along the jack shaft 118 to the second axis extending along the drive shaft 180 the drive sprocket 170 may be positioned below the clutch assembly 110, allowing for the transmission assembly 100 to have a smaller footprint.

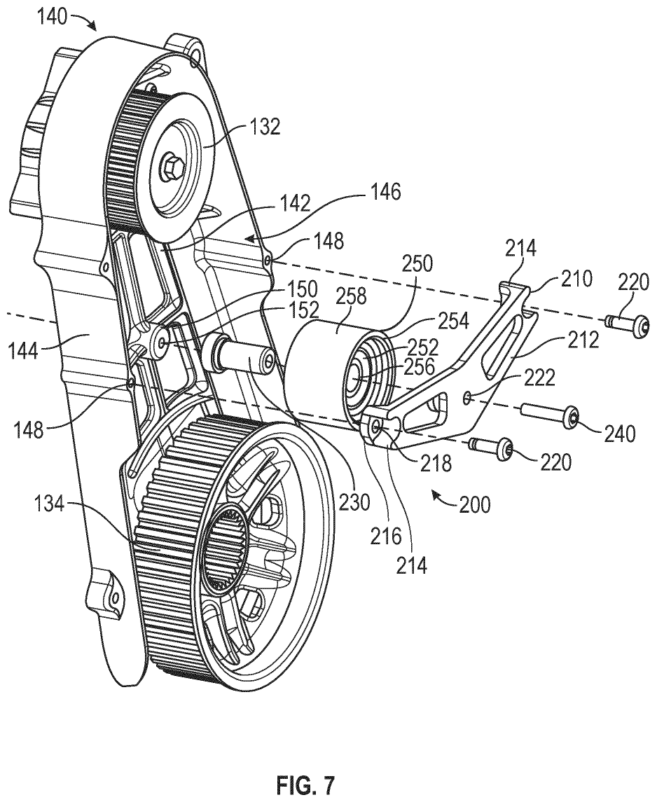

As shown in FIGS. 5-7, the belt housing 140 includes a base portion (e.g., a base, a base plate, a first portion, a first housing portion, etc.), shown as housing base portion 142, and walls (e.g., wall plates, a second housing portion, a second portion, etc.), shown as housing walls 144 coupled to the housing base portion 142 and extending outward from edges of the housing base portion 142. In some embodiments, the housing base portion 142 defines a first aperture (e.g., a jack shaft aperture, etc.) extending through the housing base portion 142 and configured to align with the jack shaft 118 to receive the jack shaft 118 and/or a second aperture (e.g., a drive shaft aperture, etc.) extending through the housing base portion 142 and configured to align with the drive shaft 180 to receive the drive shaft 180. In some embodiments, the housing walls 144 extend perpendicularly from the edges of the housing base portion 142. As shown in FIG. 7, the housing base portion 142 and the housing walls 144 collectively define a cavity (e.g., an opening, a housing cavity, etc.), shown as housing opening 146, configured to receive the top drive sprocket 132, the bottom drive sprocket 134, and the drive belt 136. When the top drive sprocket 132, the bottom drive sprocket 134, and the drive belt 136 are positioned within the housing opening 146, the housing base portion 142 and/or the housing walls 144 may protect the top drive sprocket 132, the bottom drive sprocket 134, and/or the drive belt 136 (e.g., protect from contaminants, protect from projectiles, etc.). According to an exemplary embodiment, the housing base portion 142 and the housing walls 144 are integrally formed (e.g., form a single weldment, welded, etc.). In other embodiments, the housing base portion 142 and the housing walls 144 are otherwise coupled together (e.g., fastened, etc.).

The configuration of the belt assembly 130 may depend on positions of the drive sprocket 170 and the front tractive assembly 58 and/or the rear tractive assembly 56. By way of example, the top drive sprocket 132 may be driven by the jack shaft 118 to rotate about the first axis extending along the length of the jack shaft 118 and the drive belt 136 may drive the bottom drive sprocket 134 to rotate about the second axis extending along the length of the drive shaft 180. In other embodiments, the belt assembly 130 includes other systems configured to transfer the power from the top drive sprocket 132 to the bottom drive sprocket 134 (e.g., other than using the drive belt 136, etc.). By way of example, the belt assembly 130 may include a chain engaged with the top drive sprocket 132 and the bottom drive sprocket 134 and configured to be driven by the rotation of the top drive sprocket 132 to rotate the bottom drive sprocket 134 to transfer the power from the top drive sprocket 132 to the bottom drive sprocket 134. By way of another example, the belt assembly 130 may include at least one gear engaged with the top drive sprocket 132 and the bottom drive sprocket 134 and configured to be driven by the rotation of the top drive sprocket 132 to rotate the bottom drive sprocket 134 to transfer the power from the top drive sprocket 132 to the bottom drive sprocket 134.

In some embodiments, the belt assembly 130 is configured as a spline engaged belt assembly where the top drive sprocket 132 defines a first spline pattern (e.g., a first tooth pattern, a first serration pattern, etc.) around a first outer diameter of the top drive sprocket 132, the bottom drive sprocket 134 defines a second spline pattern (e.g., a second tooth pattern, a second serration pattern, etc.) around a second outer diameter of the bottom drive sprocket 134, and the drive belt 136 defines a belt spline pattern (e.g., a belt tooth pattern, a belt serration pattern, etc.) configured to engage the first spline pattern of the top drive sprocket 132 and the second spline pattern of the bottom drive sprocket 134 to transfer the power from the top drive sprocket 132 to the bottom drive sprocket 134. The belt spline pattern of the drive belt 136 may be positioned on a first side of the drive belt 136 configured to engage the first spline pattern of the top drive sprocket 132 and the second spline pattern of the bottom drive sprocket 134.

In some embodiments, a configuration of the top drive sprocket 132, the bottom drive sprocket 134, and/or the drive belt 136 varies based on a desired gear ratio of the belt assembly 130. By way of example, the desired gear ratio of the belt assembly 130 may vary depending on a desired use of the vehicle 10 (e.g., a 1:3 ratio may be provided when the first spline pattern of the top drive sprocket 132 includes ten teeth (e.g., ten teeth, etc.) and the second spline pattern of bottom drive sprocket 134 includes thirty teeth, when the top drive sprocket 132 has a first diameter and the bottom drive sprocket 34 has a second diameter that is three times the first diameter, etc.). A length of the drive belt 136 may be determined based on the first spline pattern of the top drive sprocket 132, the second spline pattern of the bottom drive sprocket 134, and an engagement distance between the top drive sprocket 132 and the bottom drive sprocket 134 (e.g., a distance between a first central axis of the top drive sprocket 132 and a second central axis of the bottom drive sprocket 134, a distance between the first axis of the jack shaft 118 and the second axis of the drive shaft 180, distance, etc.). The engagement distance is a distance between the top drive sprocket 132 and the bottom drive sprocket 134 that allows for the drive belt 136 to engage the top drive sprocket 132 and the bottom drive sprocket 134 to transfer power between the top drive sprocket 132 and the bottom drive sprocket 134 when the drive belt 136 extends directly between the bottom drive sprocket 134 and top drive sprocket 132. The engagement distance may depend on a length of the drive belt 136, a first size (e.g., a first diameter, etc.) of the top drive sprocket 132, a second size (e.g., a second diameter, etc.) of the bottom drive sprocket 134, and/or a path length of the drive belt 136 through the belt assembly 130 (e.g., a length of a path of the drive belt 136 around the top drive sprocket 132 and the bottom drive sprocket 134, etc.). Different gear ratios of the belt assembly 130 may be desired by the operator of the vehicle 10 in order to adjust the performance of the vehicle 10 (e.g., increase a torque provided by the prime mover 52 to the rear tractive assembly 56, increase a speed of the rear tractive assembly 56 as the rear tractive assembly 56 is driven by the prime mover 52, etc.).

According to an exemplary embodiment, the belt assembly 130 is modified in order to change the gear ratio of the belt assembly 130. By being able to modify the belt assembly 130 to change the gear ratio of the belt assembly 130, a transmission assembly gear ratio of the transmission assembly 100 may be modified without replacing the belt assembly 130. By way of example, in order to change the gear ratio of the belt assembly 130 from a first gear ratio of 1:3 where a first of the top drive sprockets 132 includes ten teeth, a second of the bottom drive sprockets 134 includes thirty teeth, and a first of the drive belts 136 engages the top drive sprocket 132 and the bottom drive sprocket 134 to a second gear ratio of 2:3, the first of the top drive sprockets 132 may be exchanged for a second of the top drive sprockets 132 that includes twenty teeth and the first of the drive belts 136 may be exchanged for a second of the drive belts 136 due to the change of the first spline pattern from the first of the top drive sprockets 132 to the second of the top drive sprockets 132. As another example, in order to change the gear ratio of the belt assembly 130 from the first gear ratio of 1:3 to a third gear ratio of 1:4, the first of the bottom drive sprockets 134 may be exchanged for a second of the bottom drive sprockets 134 that includes forty teeth and the first of the drive belts 136 may be exchanged for a third of the drive belts 136 due to the change of the second spline pattern from the first of the bottom drive sprockets 134 to the second of the bottom drive sprockets 134.

In some embodiments, the belt assembly 130 is configured such that the engagement distance between the top drive sprocket 132 and the bottom drive sprocket 134 may be adjusted (e.g., modified, changed, etc.). As a result, a tension of the drive belt 136 may be adjusted (e.g., the tension of the drive belt 136 may be increased or decreased, etc.) and/or different combinations of the top drive sprocket 132, bottom drive sprocket 134, and/or the drive belt 136 may be used without changing the belt housing 140 of the belt assembly 130. By way of example, if a first combination of a first of the top drive sprockets 132, a first of the bottom drive sprockets 134, and a first of the drive belts 136 may require a first engagement distance between the top drive sprocket 132 and the bottom drive sprocket 134 to properly engage the first of the top drive sprockets 132 and the first of the bottom drive sprockets 134 and a second combination of a second of the top drive sprockets 132, a second of the bottom drive sprockets 134, and a second of the drive belts 136 may require a second engagement distance between the top drive sprocket 132 and the bottom drive sprocket 134 to properly engage the second of the top drive sprockets 132 and the second of the bottom drive sprockets 134, the belt assembly 130 may be adjusted so that the engagement distance between the top drive sprocket 132 and the bottom drive sprocket 134 is the first engagement distance when the belt assembly 130 includes the first combination and the engagement distance between the top drive sprocket 132 and the bottom drive sprocket 134 is the second engagement distance when the belt assembly 130 includes the second combination.

As shown in FIG. 5, the belt assembly 130 includes a first bearing retainer (e.g., first eccentric bearing retainer, jack shaft bearing retainer, etc.), shown as jack shaft adjustable bearing retainer 160, configured to change the engagement distance between the top drive sprocket 132 and the bottom drive sprocket 134. The jack shaft adjustable bearing retainer 160 is coupled to the belt housing 140 and configured to receive a first bearing (e.g., a first bushing, etc.), shown as jack shaft bearing 162, coupled to the jack shaft 118. The jack shaft bearing 162 is configured to rotatably support a portion of the jack shaft 118 positioned near the top drive sprocket 132 relative to the belt housing 140 via the jack shaft adjustable bearing retainer 160. The jack shaft adjustable bearing retainer 160 is configured to adjust a position of the jack shaft bearing 162 relative to the belt housing 140 in order to adjust a position of the jack shaft 118 relative to the belt housing 140, and thereby the engagement distance between the top drive sprocket 132 and the bottom drive sprocket 134. By way of example, a first adjustment portion of the jack shaft adjustable bearing retainer 160 may be configured to rotate about a first central adjustment axis of the jack shaft adjustable bearing retainer 160 and the jack shaft bearing 162 may not be centered on the first central adjustment axis of the jack shaft adjustable bearing retainer 160 (e.g., a first rotational axis may be offset from the first bearing axis of the jack shaft adjustable bearing retainer 160, etc.). As a result, as the first adjustment portion of the jack shaft adjustable bearing retainer 160 is rotated about the first central adjustment axis of the jack shaft adjustable bearing retainer 160, a first bearing axis of the jack shaft bearing 162 is rotated around the first central adjustment axis of the jack shaft adjustable bearing retainer 160, changing the position of the top drive sprocket 132 relative to the belt housing 140, and thereby changing the engagement distance between the top drive sprocket 132 and the bottom drive sprocket 134.

As shown in FIG. 5, the belt assembly 130 includes a second bearing retainer (e.g., second eccentric bearing retainer, drive shaft bearing retainer, etc.), shown as drive shaft adjustable bearing retainer 164, configured to change the engagement distance between the top drive sprocket 132 and the bottom drive sprocket 134. The drive shaft adjustable bearing retainer 164 is coupled to the belt housing 140 and configured to receive a second bearing (e.g., a second bushing, etc.), shown as drive shaft bearing 166, coupled to the drive shaft 180. The drive shaft bearing 166 is configured to rotatably support a portion of the drive shaft 180 positioned near the bottom drive sprocket 134 relative to the belt housing 140 via the drive shaft adjustable bearing retainer 164. The drive shaft adjustable bearing retainer 164 is configured to adjust a position of the drive shaft bearing 166 relative to the belt housing 140 in order to adjust a position of the drive shaft 180 relative to the belt housing 140, and thereby the engagement distance between the top drive sprocket 132 and the bottom drive sprocket 134. By way of example, a second adjustment portion of the drive shaft adjustable bearing retainer 164 may be configured to rotate about a second central adjustment axis of the drive shaft adjustable bearing retainer 164 and the drive shaft bearing 166 may not be centered on the second central adjustment axis of the drive shaft adjustable bearing retainer 164 (e.g., a second bearing axis of drive shaft bearing 166 may be offset from the second central adjustment axis of the drive shaft adjustable bearing retainer 164, etc.). As a result, as the second adjustment portion of the drive shaft adjustable bearing retainer 164 is rotated about the second central adjustment axis of drive shaft adjustable bearing retainer 164, a second bearing axis of the drive shaft bearing 166 is rotated around the second central adjustment axis of the drive shaft adjustable bearing retainer 164, changing the position of the top drive sprocket 132 relative to the belt housing 140, and thereby changing the engagement distance between the top drive sprocket 132 and the bottom drive sprocket 134.

However, the belt assembly 130 may be limited in adjusting the engagement distance between the top drive sprocket 132 and the bottom drive sprocket 134 based on the jack shaft bearing 162 and the drive shaft bearing 166. By way of example, the belt assembly 130 may be limited in adjusting the engagement distance between the top drive sprocket 132 and the bottom drive sprocket 134 between (a) a maximum engagement distance when the jack shaft adjustable bearing retainer 160 and the drive shaft adjustable bearing retainer 164 are in a first configuration that positions the jack shaft bearing 162 in a top position relative to the jack shaft adjustable bearing retainer 160 and the drive shaft bearing 166 in a bottom position relative to the drive shaft adjustable bearing retainer 164 and (b) a minimum engagement distance when the jack shaft adjustable bearing retainer 160 and the drive shaft adjustable bearing retainer 164 are in a second configuration that positions the jack shaft bearing 162 in a bottom position relative to the jack shaft adjustable bearing retainer 160 and the drive shaft bearing 166 in a top position relative to the drive shaft adjustable bearing retainer 164. The limits of the belt assembly 130 related to adjusting the engagement distance between the top drive sprocket 132 and the bottom drive sprocket 134 may limit the combinations of the top drive sprocket 132, the bottom drive sprocket 134, and the drive belt 136 that may be used in the belt assembly 130 to change the gear ratio of the belt assembly 130. By way of example, if a combination of the top drive sprocket 132, the bottom drive sprocket 134, and the drive belt 136 require an engagement distance that is greater than the maximum engagement distance of the belt assembly 130, the combination of the top drive sprocket 132, the bottom drive sprocket 134, and the drive belt 136 may not achieve an appropriate amount of engagement between the drive belt 136 and the top drive sprocket 132 and/or the bottom drive sprocket 134 when the drive belt 136 extends directly between the top drive sprocket 132 and the bottom drive sprocket 134. As a result, an assembly that increases the possible combinations of the top drive sprocket 132, the bottom drive sprocket 134, and the drive belt 136 of the belt assembly 130 without requiring a change in the belt housing 140 may be desired, as described in greater detail herein.

### Belt Idler Assembly

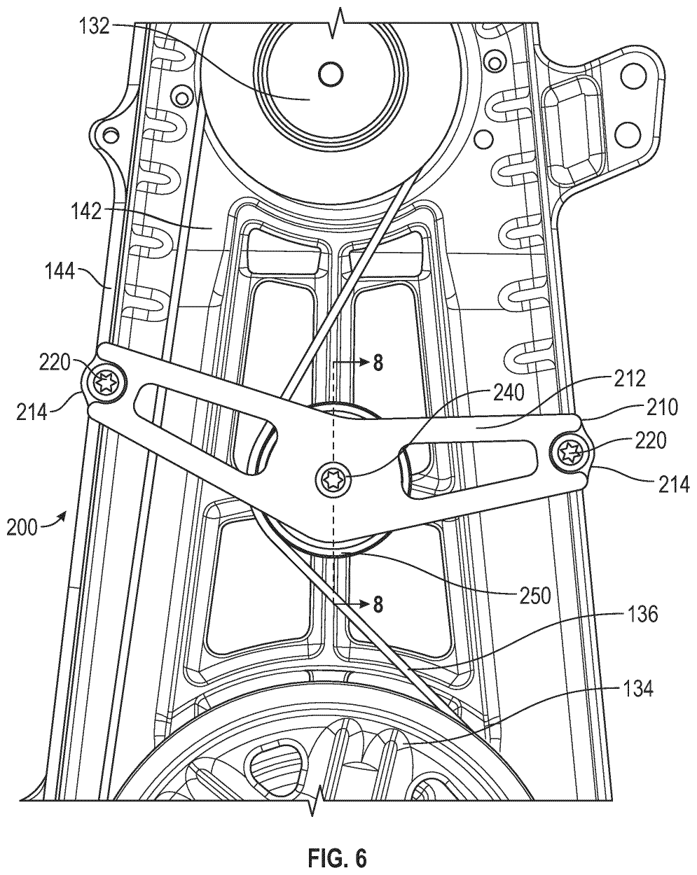

As shown in FIGS. 6-8, the transmission assembly 100 includes an idler assembly (e.g., a tensioner assembly, a belt guide assembly, etc.), shown as belt idler assembly 200, coupled to the belt housing 140 of the belt assembly 130 and configured to engage the drive belt 136 to change a path of the drive belt 136. By way of example, the belt idler assembly 200 may engage the drive belt 136 in-between the top drive sprocket 132 and the bottom drive sprocket 134 to lengthen the path of the drive belt 136 between the top drive sprocket 132 and the bottom drive sprocket 134. In some embodiment, the belt idler assembly 200 increases an engagement length (e.g., an amount of engagement, a length of a contact area, etc.) between (i) the drive belt 136 and (ii) the top drive sprocket 132 and/or the bottom drive sprocket 134. By way of example, the belt idler assembly 200 may increase a wrap of the drive belt 136 around the top drive sprocket 132 and/or the bottom drive sprocket 134. As a result, additional teeth of the belt spline pattern of the drive belt 136 may engage with additional teeth of the first spline pattern of the top drive sprocket 132 and/or the second spline pattern of the bottom drive sprocket 134, increasing a distribution of the loads transferred between (i) the drive belt 136 and (ii) the top drive sprocket 132 and/or the bottom drive sprocket 134 to decrease loads applied on each of the teeth of the spline patterns and decreasing a possibility of the drive belt 136 slipping relative to the top drive sprocket 132 and/or the bottom drive sprocket 134.

As shown in FIG. 7, the belt housing 140 defines a plurality of first apertures, (e.g., coupling apertures, fastener apertures, etc.), shown as mounting apertures 148, extending at least partially through the belt housing 140. The mounting apertures 148 are configured to couple the belt idler assembly 200 to the belt housing 140 (e.g., via fasteners, etc.). According to the exemplary embodiment shown in FIG. 7, the mounting apertures 148 are positioned on the housing walls 144 of the belt housing 140 and extend at least partially through a height of the housing walls 144. By way of example, a first of the mounting apertures 148 may be positioned on a first portion of the housing walls 144 positioned on a first side of the belt housing 140 and a second of the mounting apertures 148 may be positioned on a second portion of the housing walls 144 positioned on a second opposing side of the belt housing 140. In other embodiments, the mounting apertures 148 are positioned on the housing base portion 142 of the belt housing 140. In still other embodiments, the belt housing 140 defines a single one of the mounting apertures 148.

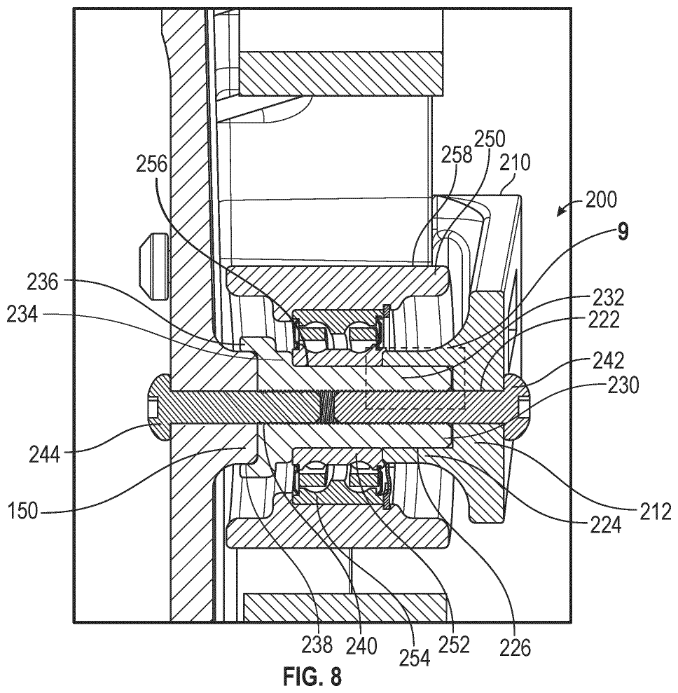

As shown in FIGS. 7 and 8, the belt housing 140 includes a protrusion (e.g., an extension, a bump, a third portion, a third housing portion, etc.), shown as projection 150, extending outward from the housing base portion 142. The projection 150 extends outward from the housing base portion 142 in a same direction that the housing walls 144 extend from the edges of the housing base portion 142. According to the exemplary embodiment shown in FIGS. 7 and 8, the projection 150 has a circular cross-sectional shape as the projection 150 extends outward from the housing base portion 142. In other embodiments, the projection 150 has a non-circular cross sectional shape (e.g., rectangular, square, hexagon, octagon, oval, etc.). As shown in FIG. 7, the belt housing 140 defines a third aperture (e.g., a retainer aperture, etc.), shown as projection aperture 152, extending through the projection 150 and the housing base portion 142 of the belt housing 140. The projection aperture 152 may be centered on the projection 150 of the belt housing 140 (e.g., at a center of the projection 150, etc.).

As shown in FIGS. 6-8, the belt idler assembly 200 includes a bracket (e.g., a tensioner bracket, etc.), shown as idler bracket 210, coupled to the belt housing 140, a post (e.g., a tensioner post, etc.), shown as idler post 230, positioned and/or coupled between the belt housing 140 and the idler bracket 210, and a third bearing (e.g., a third bushing, etc.), shown as idler bearing 250, coupled to the idler post 230 and configured to engage the drive belt 136 between the top drive sprocket 132 and the bottom drive sprocket 134. The idler bracket 210 may extend across the housing opening 146 of the belt housing 140. When the belt idler assembly 200 is coupled to the belt housing 140 and the idler bearing 250 engages the drive belt 136, a path of the drive belt 136 between the top drive sprocket 132 and the bottom drive sprocket 134 is changed from a direct path (e.g., a straight path, etc.) from the top drive sprocket 132 to the bottom drive sprocket 134 that has a first path length to an indirect path (e.g., a skewed path, a non-straight path, etc.) from the top drive sprocket 132 to the bottom drive sprocket 134 that has a second path length that is greater than the first path length of the direct path. In some embodiments, the idler bearing 250 is positioned at least partially between the top drive sprocket 132 and the bottom drive sprocket 134.

As shown in FIGS. 6-11, the idler bracket 210 includes a base portion (e.g., a base, a base plate, a first bracket portion, etc.), shown as idler bracket base portion 212, a plurality of extension portions (e.g., bracket legs, bracket arms, a second bracket portions, etc.), shown as bracket extension portions 214, extending outward from opposing ends of the idler bracket base portion 212, and a plurality of retainers (e.g., retaining portions, a third bracket portions, etc.), shown as bracket interlocks 216. According to an exemplary embodiment, each of the bracket interlocks 216 extends from an end of one of the bracket extension portions 214 and is configured to interface with the housing walls 144 of the belt housing 140 to prevent lateral and/or vertical movement of the idler bracket 210 relative to the belt housing 140. By way of example, a first of the bracket interlocks 216 may be configured to match a first profile of a first surface (e.g., a first inside surface, a first outside surface, etc.) of a first portion of the housing walls 144 positioned on a first side of the belt housing 140 and a second of the bracket interlocks 216 may be configured to match a second profile of a second surface (e.g., a second inside surface, a second inside surface, etc.) of a second portion of the housing walls 144 positioned on a second opposing side of the belt housing 140. When the idler bracket 210 is coupled to the belt housing 140, the first of the bracket interlock 216 engages the first surface of the first portion of the housing walls 144 to prevent movement of the idler bracket 210 relative to the belt housing 140 in at least one first direction and the second of the bracket interlock 216 engages the second surface of the second portion of the housing walls 144 to prevent movement of the idler bracket 210 relative to the belt housing 140 in at least one second opposing direction opposing the at least one first direction.

In some embodiments, the bracket extension portions 214 extends perpendicularly from the opposing ends of the idler bracket base portion 212 and/or the bracket interlocks 216 may extend perpendicularly from the ends of the bracket extension portions 214. According to an exemplary embodiment, the idler bracket base portion 212, the bracket extension portions 214, and the bracket interlocks 216 are integrally formed. In other embodiments, the idler bracket base portion 212, the bracket extension portions 214, and/or the bracket interlocks 216 are otherwise coupled together. According to an exemplary embodiment, the bracket extension portions 214 and the bracket interlock portions 216 cooperatively define a recess or cavity (e.g., a keyed recess, a specifically shaped recess, etc.) that corresponds with the shape of the housing walls 144 surrounding the mounting apertures 148 (e.g., cylindrical, rectangular, a bracket interface, etc.). By way of example, the portions or interfaces of the housing walls 144 surrounding the mounting apertures 148 may protrude outwards/inwards from the housing walls 114. The recesses of the idler bracket 210 may interface with the shape of or interfaces of the housing walls 144 surrounding the mounting apertures 148 to guide the positioning of the idler bracket 210 and secure it horizontally and/or vertically in place.

As shown in FIGS. 7, 10, and 11, the idler bracket 210 defines a plurality of second apertures, shown as bracket apertures 218, extending through the idler bracket 210. The bracket apertures 218 are configured to align with the mounting apertures 148 of the belt housing 140 to selectively receive a plurality of fasteners (e.g., bolts, screws, rivets, nails, anchors, etc.), shown as bracket fasteners 220, to removably couple the idler bracket 210 to the belt housing 140. According to the exemplary embodiment shown in FIGS. 7, 10, and 11, the bracket apertures 218 extend through the bracket extension portions 214 of the idler bracket 210 to align with mounting apertures 148 of the belt housing 140. By way of example, the bracket fasteners 220 may extend through the bracket extension portions 214 of the idler bracket 210 when removably coupling the idler bracket 210 to the belt housing 140. In other embodiments, the bracket apertures 218 extend through the idler bracket base portion 212 and/or the bracket extension portions 214 of the idler bracket 210 to align with the mounting apertures 148 of the belt housing 140.

As shown in FIGS. 7-9, and 11, the idler bracket 210 defines a fourth aperture, shown as axle aperture 222, extending through the idler bracket 210 (e.g., at or proximate a center thereof). In some embodiments, the axle aperture 222 is configured to couple the idler post 230 to the idler bracket 210 (e.g., via fasteners, etc.). The axle aperture 222 extends through the idler bracket base portion 212 of the idler bracket 210. According to an exemplary embodiment, the axle aperture 222 aligns with the projection aperture 152 of the belt housing 140 when the idler bracket 210 is coupled to the belt housing 140. In other embodiments, the idler bracket 210 does not define the axle aperture 222 (e.g., when the idler bracket 210 is not coupled to the idler post 230, etc.).

As shown in FIGS. 8-11, the idler bracket 210 includes an extrusion portion (e.g., a raised portion, a protruded portion, etc.), shown as bracket extrusion 224, extending from the idler bracket base portion 212 of the idler bracket 210. The bracket extrusion 224 may extend from the idler bracket base portion 212 in the same direction that the bracket extension portions 214 extend from the idler bracket base portion 212 and/or the same direction that the bracket interlocks 216 extend from the bracket extension portions 214. As shown in FIG. 11, the bracket extrusion 224 aligns with the axle aperture 222. As shown in FIGS. 8, 9, and 11, the bracket extrusion 224 defines a first opening (e.g., post receiving opening, etc.), shown as bracket opening 226, configured to receive a second portion of the idler post 230. According to the exemplary embodiment shown in FIGS. 8, 9, and 11, the bracket opening 226 has a circular cross-sectional shape. In other embodiments, the bracket opening 226 has a non-circular cross-sectional shape (e.g., rectangular, square, hexagon, octagon, oval, etc.). In various embodiments, the bracket opening 226 extends through the bracket extrusion 224 and/or at least partially through the idler bracket base portion 212.

As shown in FIGS. 8-10, the idler post 230 includes a post body (e.g., a cylindrical portion, etc.), shown as post portion 232, positioned at a first end of the idler post 230 and configured to align with and be received by the bracket opening 226, a shoulder body (e.g., a bearing shoulder, etc.), shown as post shoulder portion 234, extending outward from an outside surface of the post portion 232 (e.g., having a larger diameter than the post portion 232, etc.) and configured to support the idler bearing 250, and a protrusion receiving body, shown as protrusion receiving portion 236, extending from an opposing second end of the idler post 230. According to an exemplary embodiment, the post portion 232 has a cross-sectional shape that corresponds with the cross-sectional shape of the bracket opening 226. According to the exemplary embodiment shown in FIGS. 8-11, the post portion 232, the post shoulder portion 234, and the protrusion receiving portion 236 have circular cross-sectional shapes. In other embodiments, the post portion 232, the post shoulder portion 234, and/or the protrusion receiving portion 236 have a non-circular cross-sectional shape (e.g., rectangular, square, hexagon, octagon, oval, etc.). According to an exemplary embodiment, the post portion 232, the post shoulder portion 234, and the protrusion receiving portion 236 are integrally formed. In other embodiments, the post portion 232, the post shoulder portion 234, and/or the protrusion receiving portion 236 are otherwise coupled together.

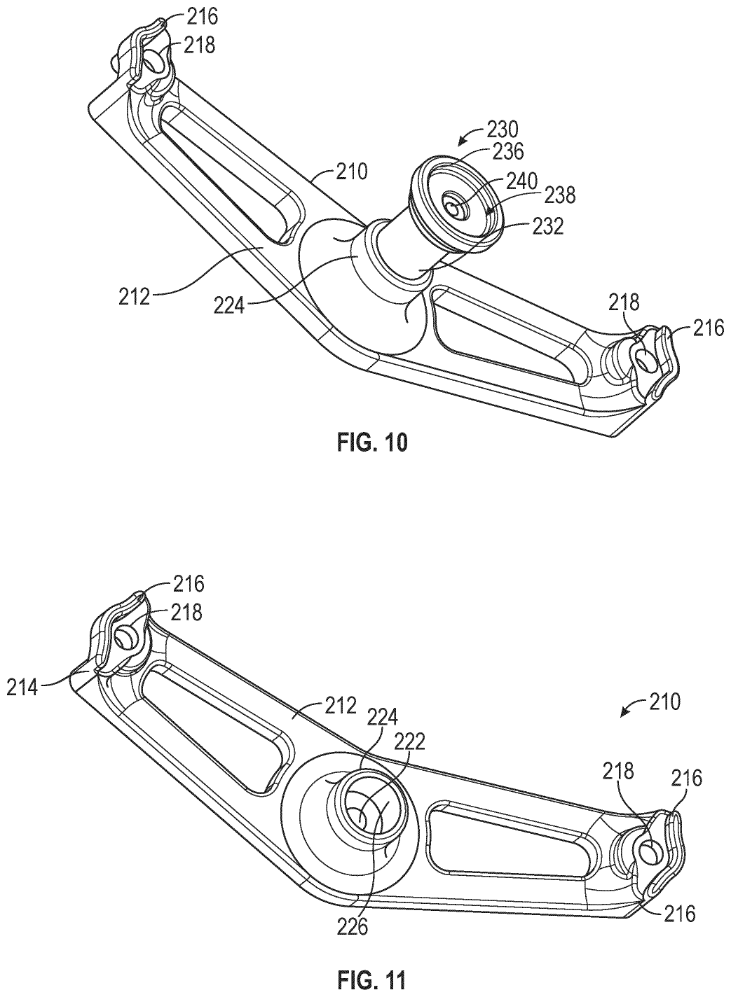

As shown in FIGS. 8 and 10, the protrusion receiving portion 236 defines a second opening or recess, shown as projection opening 238, configured to align with the projection 150 of the belt housing 140 to receive the projection 150. According to an exemplary embodiment, the projection opening 238 has a cross-sectional shape that corresponds with the projection 150 of the belt housing 140. According to the exemplary embodiment shown in FIGS. 8 and 10, the projection opening 238 has a circular cross-sectional shape. In other embodiments, the projection opening 238 has a non-circular cross-sectional shape. When the projection opening 238 receives the projection 150 of the belt housing 140 and the post portion 232 is received by the bracket opening 226 of the idler bracket 210, the idler post 230 may be contained between the belt housing 140 and the idler bracket 210 to couple the idler post 230 between the belt housing 140 and the idler bracket 210. By way of example, when the belt idler assembly 200 is coupled to the belt housing 140, the projection opening 238 of the idler post 230 may first receive the projection 150 of the belt housing 140, then the bracket opening 226 of the idler bracket 210 may receive the post portion 232 of the idler post 230 when the idler bracket 210 is placed over the idler post 230 to contain (e.g., trap, couple, etc.) the idler post 230 between the belt housing 140 and the idler bracket 210.

According to the exemplary embodiment shown in FIGS. 8-10, the idler post 120 defines a fifth aperture, shown as post aperture 240, extending through the post portion 232 and the post shoulder portion 234. The post aperture 240 is configured to (i) align with the axle aperture 222 of the idler bracket 210 to selectively receive a first fastener (e.g., a bolt, a screw, a rivet, a nail, an anchor, etc.), shown as post fastener 242, to removably couple the idler post 230 to the idler bracket 210 and (ii) align with the with the projection aperture 152 to selectively receive a second fastener, shown as housing fastener 244, to removably couple the idler post 230 to the belt housing 140. In other embodiments, the post aperture 240 does not receive the post fastener 242 and the idler post 230 is coupled to the idler bracket 210 by the post portion 232 being received by the bracket opening 226. In other embodiments, the post aperture 240 does not receive the housing fastener 244 and the idler post 230 is coupled to the projection 150 via a compression fit.

In various embodiments, the post aperture 240 does not receive the housing fastener 244 and the idler post 230 is coupled to the belt housing 140 by the projection opening 238 receiving the projection 150. When the idler post 230 is coupled to the belt housing 140 through the other means, the belt idler assembly 200 may be coupled to the belt housing 140 without accessing a backside of the belt housing 140 (e.g., a side of the belt housing 140 opposing the housing opening 146, while only accessing a single side of the belt housing 140, etc.). By way of example, when the idler post 230 is coupled to the belt housing 140 through the other means, the idler post 230 and the idler bearing 250 may be inserted into the housing opening 146 from a front side of the belt housing 140, the post fastener 242 may be inserted through the axle aperture 222 into the post aperture 240 to couple the idler bracket 210 to the idler post 230 from the front side of the belt housing 140, and the bracket fasteners 220 may be inserted through the bracket apertures 218 into the mounting apertures 148 to couple the idler bracket 210 to the belt housing 140 from the front side of the belt housing 140. As result, the belt idler assembly 200 may be coupled to the belt housing 140 when another component of the vehicle 10 blocks access to the back side of the belt housing 140. By way of example, the belt idler assembly 200 may be coupled to the belt housing 140 where the tunnel 22 of the body 20 blocks access to the back side of the belt housing 140.

As shown in FIGS. 7-9, the idler bearing 250 include an inner portion, shown as inner bearing portion 252, coupled to the idler post 230, and an outer portion, shown as outer bearing portion 254, rotatably coupled to the inner bearing portion 252 and configured to engage the drive belt 136. The outer bearing portion 254 may be configured to rotate relative to the inner bearing portion 252 with relatively little friction between the outer bearing portion 254 and the inner bearing portion 252. By way of example, the idler bearing 250 may be configured as a ball style bearing with greased ball bearings positioned between the inner bearing portion 252 and the outer bearing portion 254 to reduce the friction between the inner bearing portion 252 and the outer bearing portion 254.

As shown in FIGS. 7-9, the inner bearing portion 252 defines a sixth aperture, shown as bearing aperture 256, extending through the inner bearing portion 252. The bearing aperture 256 is configured to align with the post portion 232 of the idler post 230 to receive the post portion 232 to couple the idler bearing 250 to the idler post 230. When the post portion 232 is received by the bearing aperture 256, the inner bearing portion 252 of the idler bearing 250 may be positioned between the post shoulder portion 234 of the idler post 230 and the bracket extrusion 224 of the idler bracket 210. By way of example, when the post fastener 242 extends through the axle aperture 222 into the post aperture 240 to couple the idler bracket 210 to the idler post 230, the post fastener 242 may engage threads defined by the post aperture 240 and draw the idler post 230 towards the idler bracket 210. As the idler post 230 is drawn towards the idler bracket 210, the inner bearing portion 252 may be clamped between the bracket extrusion 224 of the idler bracket 210 and the post shoulder portion 234 of the idler post 230 to prevent rotation of the inner bearing portion 252 relative to the idler post 230 or the idler bracket 210. As another example, when the bracket fasteners 220 couple the idler bracket 210 to the belt housing 140, the bracket extrusion 224 of the idler bracket 210 may provide a clamp force on the inner bearing portion 252 of the idler bearing 250 to clamp the inner bearing portion 252 between the post shoulder portion 234 of the idler post 230 and the bracket extrusion 224 of the idler bracket 210 to prevent rotation of the inner bearing portion 252 relative to the idler post 230 or the idler bracket 210.

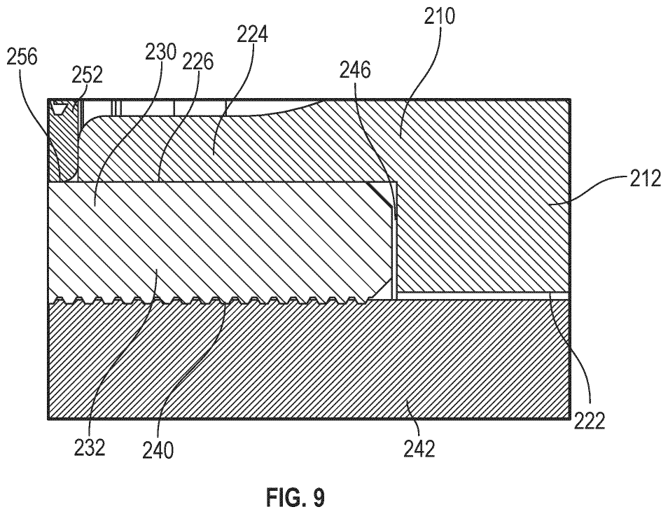

According to the exemplary embodiment shown in FIG. 9, a length of the idler post 230 of the idler post 230 and/or a depth of the bracket opening 226 is configured such that a gap, shown as post gap 246, is defined between an end of a portion of the post portion 232 received by the bracket opening 226 and a bottom surface (e.g., a bottom, etc.) of the bracket opening 226. As a result of the post gap 246 being positioned between the end of the portion of the post portion 232 received by the bracket opening 226 and a bottom of the bracket opening 226, the inner bearing portion 252 may be clamped between the bracket extrusion 224 of the idler bracket 210 and post shoulder portion 234 of the idler post 230 without the post portion 232 bottoming out on the bottom surface of the bracket opening 226.

As shown in FIGS. 7 and 8, the outer bearing portion 254 defines a surface, shown as bearing surface 258, configured to engage (e.g., contact, etc.) the drive belt 136. According to the exemplary embodiment shown in FIGS. 7 and 8, the bearing surface 258 is a smooth surface that contacts the drive belt 136 and the outer bearing portion 254 is rotated by the drive belt 136 via friction between the outer bearing portion 254 and a smooth surface of the drive belt 136 on an opposing side of the drive belt 136 from the belt spline pattern of the drive belt 136. In other embodiments, the bearing surface 258 defines a bearing spline pattern configured to engage the belt spline pattern of the drive belt 136 and the outer bearing portion 254 is rotated by engagement between the bearing spline pattern of the bearing surface 258 and the belt spline pattern of the drive belt 136.

According to the exemplary embodiment shown in FIG. 6, a path length of the drive belt 136 through the belt assembly 130 is greater than a direct path length of the drive belt 136 wrapped around the top drive sprocket 132 and the bottom drive sprocket 134 and extending directly between the top drive sprocket 132 and the bottom drive sprocket 134 when a first portion of the drive belt 136 extending from the top drive sprocket 132 to the bottom drive sprocket 134 in a direction of travel of the drive belt 136 is at least partially wrapped around the bearing surface 258 of the idler bearing 250 of the belt idler assembly 200. By allowing for the path length of the drive belt 136 to be greater than the direct path length of the drive belt 136, the belt idler assembly 200 may allow for configurations of the top drive sprocket 132, the bottom drive sprocket 134, and the drive belt 136 to be included in the belt assembly 130 that typically would not fit within the housing opening 146 of the belt housing 140. By way of example, a combination of the top drive sprocket 132, the bottom drive sprocket 134, and the drive belt 136 may typically have an engagement distance between the top drive sprocket 132 and the bottom drive sprocket 134 when the drive belt 136 extends directly between the top drive sprocket 132 and the bottom drive sprocket 134 based on the length of the drive belt 136. If the engagement distance between the top drive sprocket 132 and the bottom drive sprocket 134 is greater than the maximum distance available between the top drive sprocket 132 and the bottom drive sprocket 134 when the top drive sprocket 132 and the bottom drive sprocket 134 are positioned in the housing opening 146, the combination may not fit into the belt assembly 130 when the drive belt 136 extends directly between the top drive sprocket 132 and the bottom drive sprocket 134. However, when the drive belt 136 is wrapped at least partially around the idler bearing 250, the top drive sprocket 132, the bottom drive sprocket 134, and the drive belt 136 may have a modified engagement distance between the top drive sprocket 132 and the bottom drive sprocket 134 that is less than the engagement distance due to the drive belt 136 being wrapped around the idler bearing 250. When the modified engagement distance is between the maximum distance and the minimum distance between the top drive sprocket 132 and the bottom drive sprocket 134 of the belt assembly 130, the combination of the top drive sprocket 132, the bottom drive sprocket 134, and the drive belt 136 may fit in the housing opening 146 of the belt assembly 130 while allowing for engagement between the top drive sprocket 132, the bottom drive sprocket 134, and the drive belt 136, and thus can be used with the belt assembly 130 to transfer the power through the belt assembly 130. In other embodiments, the path length of the drive belt 136 through the belt assembly 130 is greater than the direct path length of the drive belt 136 wrapped around the top drive sprocket 132 and the bottom drive sprocket 134 and extending directly between the top drive sprocket 132 and the bottom drive sprocket 134 when a second portion of the drive belt 136 extending from the bottom drive sprocket 134 to the top drive sprocket 132 in the direction of travel of the drive belt 136 is at least partially wrapped around the bearing surface 258 of the idler bearing 250 of the belt idler assembly 200.

Once the drive belt 136 has been wrapped around the top drive sprocket 132, the bottom drive sprocket 134 and the bearing surface 258 of the idler bearing 250, the operator may further adjust the jack shaft adjustable bearing retainer 160 and/or the drive shaft adjustable bearing retainer 164 to increase or decrease a tension in the drive belt 136. By way of example, wrapping the drive belt 136 around the bearing surface 258 of the idler bearing 250 may provide macro adjustments to the path length of the drive belt 136 wrapped around the top drive sprocket 132 and the bottom drive sprocket 134 and adjusting the jack shaft adjustable bearing retainer 160 and/or the drive shaft adjustable bearing retainer 164 may provide micro adjustments to the path length of the drive belt 136.

According to the exemplary embodiment shown in FIG. 6, wrapping the drive belt 136 around the idler bearing 250 additionally increases a first engagement length between the first spline pattern of the top drive sprocket 132 and the belt spline pattern of the drive belt 136 and increase a second engagement length between the second spline pattern of the bottom drive sprocket 134 and the belt spine pattern of the drive belt 136. By way of example, when the drive belt 136 is wrapped around the idler bearing 250, the idler bearing 250 may pull the drive belt 136 in a direction towards a center of the top drive sprocket 132 and/or the bottom drive sprocket 134. As a result, the drive belt 136 may be wrapped further around the top drive sprocket 132 and/or the bottom drive sprocket 134 than if the drive belt 136 extended directly between the bottom drive sprocket 134 and the top drive sprocket 132. By increasing the first engagement length and/or the second engagement length, the belt idler assembly 200 may distribute the loads transferred along the first engagement length and/or the second engagement length to decrease loads applied on each of the teeth of the spline patterns and decreasing a possibility of the drive belt 136 slipping relative to the top drive sprocket 132 and/or the bottom drive sprocket 134.

In some embodiments, the path length of the drive belt 136 wrapped around the idler bearing 250 is further changed by modifying an outer diameter of the bearing surface 258 of the idler bearing 250. By way of example, the path length of the drive belt 136 may be increased by changing a first of the idler bearings 250 with the bearing surface 258 having a first outer diameter to a second of the idler bearings 250 with the bearing surface 258 having a second outer diameter that is greater than the first outer diameter. As another example, the path length of the drive belt 136 may be decreased by changing the second of the idler bearings 250 with the bearing surface 258 having the first outer diameter to a third of the idler bearings 250 with the bearing surface 258 having a third outer diameter that is less than the first outer diameter.

### Retrofit Belt Idler Assembly

According to an exemplary embodiment, the belt idler assembly 200 is manufactured as a modular kit configured to provide a retrofit solution for increasing a number of gear ratios available to a belt assembly. In some embodiments, the belt idler assembly 200 is manufactured as a modular kit configured to provide a retrofit solution for converting a belt assembly without a belt idler to a belt assembly with a belt idler. Accordingly, various different belt idler assemblies 200 can be designed and manufactured to integrate into various different belt assemblies without belt idlers. Therefore, installing the belt idler assembly 200 into an existing belt assembly of a vehicle may provide additional available gear ratios to the belt assembly (e.g., by swapping other components of the belt assembly, etc.) without requiring a purchase of a new belt assembly and/or a purchase of a new belt housing of a belt assembly.

In some embodiments, the modular kit of the belt idler assembly 200 includes multiple configurations of the idler bearing 250, the top drive sprocket 132, the bottom drive sprocket 134, and/or the drive belt 136 to allow for adjustment of the gear ratio of the belt assembly 130 based on a use of the belt assembly 130. In some embodiments, the modular kit includes a first combination of the belt idler assembly 200, a first of the top drive sprocket 132, a first of the bottom drive sprocket 134, and a first of the drive belt 136, where the first of the top drive sprocket 132, the first of the bottom drive sprocket 134, and the first of the drive belt 136 are not normally compatible in the belt assembly 130 without the belt idler assembly 200. In some embodiments the modular kit includes several of the idler bearings 250 with different outside diameters to allow for the path of the drive belt 136 between the top drive sprocket 132 and the bottom drive sprocket 134 to be changed by different amounts based which of the idler bearings 250 are used with the belt idler assembly 200. In various embodiments, the modular kit includes any number of idler bearings 250, top drive sprockets 132, bottom drive sprockets 134, and/or drive belts 136 to allow for various gear ratios of the belt assembly 130.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 80, the vehicle controller 90, etc.) as shown in the various exemplary embodiments is illustrative only. Additionally, any element disclosed in one embodiment may be incorporated or utilized with any other embodiment disclosed herein.

1. A belt idler assembly for changing a path length of a drive belt of a belt assembly of a snowmobile, the belt idler assembly comprising:
an idler bracket configured to couple to a belt housing of the belt assembly, the idler bracket comprising:
a first bracket portion,
a plurality of second bracket portions extending from opposing ends of the first bracket portion, each of the second bracket portions defining a first aperture configured to align with a second aperture of the belt housing, and
a plurality of third bracket portions extending from each of the second bracket portions, a first of the third bracket portions configured to engage with a first interface of the housing and a second of the third bracket portions configured to engage with a second interface of the housing;
a plurality of fasteners configured to extend through the first apertures and the second apertures to couple the idler bracket to the belt housing;
a post configured to be positioned between the idler bracket and the belt housing; and
a bearing coupled to the post, the bearing defining a bearing surface configured to engage the drive belt.

2. The belt idler assembly of claim 1, wherein:
the first bracket portion of the idler bracket further defines a third aperture;
the post defines a fourth aperture, the fourth aperture positioned to align with the third aperture; and
the belt idler assembly further comprises a fastener extending through the third aperture and the fourth aperture.

3. The belt idler assembly of claim 2, wherein the idler bracket defines a first opening positioned to align with the post to receive a first end of the post.

4. The belt idler assembly of claim 3, wherein:
the bearing comprises:
an inner bearing portion coupled to the post, and
an outer bearing portion rotatably coupled to the inner bearing portion, the outer bearing portion configured to engage the drive belt;
the post comprises a shoulder positioned at an opposing second end of the post; and
a first end of the inner bearing portion contacts the shoulder of the post and a second end of the inner bearing portion contacts the idler bracket.

5. The belt idler assembly of claim 4, wherein a gap is present between the first end of the post and a bottom surface of the first opening.

6. The belt idler assembly of claim 1, wherein the post defines an opening configured to receive a protruded portion of the belt housing when the idler bracket is coupled to the belt housing.

7. The belt idler assembly of claim 1, wherein the first of the third bracket portions is configured to prevent movement of the idler bracket relative to the belt housing in a first direction and the second of the third bracket portions is configured to prevent movement of the idler bracket relative to the belt housing in a second opposing direction.

8. A vehicle comprising:
a frame;
a tractive assembly coupled to the frame, the tractive assembly configured to propel the vehicle;
a prime mover configured to provide power to the tractive assembly to drive the tractive assembly;
a belt assembly configured to transfer the power from the prime mover to the tractive assembly, the belt assembly comprising:
a housing,
a first sprocket rotatably coupled to the housing and configured to receive the power from the prime mover,
a second sprocket rotatably coupled to the housing and configured to provide the power to the tractive assembly, and
a belt coupled to the first sprocket and the second sprocket, the belt configured to transfer the power between the first sprocket and the second sprocket; and
a belt idler assembly comprising:
an idler bracket coupled to the housing,
a post positioned between the housing and the idler bracket, and
a bearing coupled to the post and positioned between the first sprocket and the second sprocket;
wherein the belt wraps around at least a portion of the bearing such that a path length of the belt is greater than a direct path length of the belt when the belt extends directly between the first sprocket and the second sprocket.

9. The vehicle of claim 8, wherein:
the housing comprises a first housing portion and a second housing portion extending from an edge of the first housing portion, the second housing portion defining two or more first apertures;
the idler bracket comprises:
a first bracket portion, and
a plurality of second bracket portions extending from opposing ends of the first bracket portion, each of the second bracket portions defining a second aperture, the second aperture positioned to align with one of the first apertures of the belt housing; and
the vehicle further comprises two or more fasteners extending through the two or more first apertures and the second apertures.

10. The vehicle of claim 9, wherein:
the idler bracket further comprises:
a plurality of third bracket portions extending from each of the second bracket portions, a first of the third bracket portions engaging a first interface of the second housing portion of the housing and a second of the third bracket portions engaging a second interface of the second housing portion of the housing.

11. The vehicle of claim 8, wherein:
the housing comprises a first housing portion and a second housing portion extending from the first housing portion;
the post defines a first opening positioned at a first end of the post, the first opening receiving the second housing portion to couple the post to the housing; and
the idler bracket defines a second opening that receives a second opposing end of the post to couple the post to the idler bracket such that the post is coupled between the housing and the idler bracket.

12. The vehicle of claim 11, wherein:
the post defines a first aperture;
the idler bracket defines a second aperture, the second aperture positioned to align with the first aperture; and
the belt idler assembly further comprises a fastener extending through the first aperture and the second aperture.

13. The vehicle of claim 12, wherein:
the bearing comprises:
an inner bearing portion coupled to the post, and
an outer bearing portion rotatably coupled to the inner bearing portion, the outer bearing portion contacting the belt;
the post comprises a shoulder positioned at the first end of the post; and
a first end of the inner bearing portion contacts the shoulder of the post and a second end of the inner bearing portion contacts the idler bracket.

14. The vehicle of claim 13, wherein the fastener engages the second aperture to pull the post toward the idler bracket to clamp the inner bearing portion between the shoulder of the post and the idler bracket.

15. The vehicle of claim 12, wherein:
wherein a gap is present between the first end of the post and a bottom surface of the second opening.

16. A transmission assembly for transferring power between a prime mover and a tractive assembly of a snowmobile, the transmission assembly comprising:
a belt assembly configured to transfer the power from the prime mover to the tractive assembly, the belt assembly comprising:
a housing comprising a first housing portion and a second housing portion extending from an edge of the first housing portion, the first housing portion and the second housing portion defining a housing cavity;
a first sprocket rotatably coupled to the housing, the first sprocket positioned within the housing cavity,
a second sprocket rotatably coupled to the housing, the first sprocket positioned within the housing cavity, and
a belt coupled to the first sprocket and the second sprocket, the belt configured to transfer the power between the first sprocket and the second sprocket; and
a belt idler assembly comprising:
an idler bracket coupled to (i) a first portion of the second housing portion on a first side of the housing cavity and (ii) a second portion of the second housing portion on a second opposing side of the housing cavity,
a post positioned between the housing and the idler bracket, and
a bearing coupled to the post;
wherein the belt wraps around at least a portion of the bearing such that a path length of the belt is greater than a direct path length of the belt when the belt extends directly between the first sprocket and the second sprocket.

17. The transmission assembly of claim 16, wherein:
the housing further comprises a third housing portion extending from the first housing portion;
the post defines a first opening positioned at a first end of the post, the first opening receiving the third housing portion to couple the post to the housing; and
the idler bracket defines a second opening that receives a second opposing end of the post to couple the post to the idler bracket such that the post is coupled between the housing and the idler bracket.

18. The transmission assembly of claim 17, wherein:
wherein a gap is present between the second opposing end of the post and a bottom surface of the second opening.

19. The transmission assembly of claim 16, wherein:
the bearing comprises:
an inner bearing portion coupled to the post, and
an outer bearing portion rotatably coupled to the inner bearing portion, the outer bearing portion contacting the belt;
the post comprises a shoulder positioned at an opposing second end of the post; and
a first end of the inner bearing portion contacts the shoulder of the post and a second end of the inner bearing portion contacts the idler bracket.

20. The transmission assembly of claim 16, wherein:
the post defines a first aperture;
the idler bracket defines a second aperture, the second aperture positioned to align with the first aperture; and
the belt idler assembly further comprises a fastener extending through the first aperture and the second aperture.
